(19) United States
(12) Patent Application Publication
(10) Pub. No.: US 2025/0273415 A1
(43) Pub. Date: Aug. 28, 2025

(54) BEAUTY TOOL WITH MODE SELECTOR ASSEMBLY

(71) Applicant: Kaz Europe Sàrl, Bussigny (CH)

(72) Inventors: Jesse Thomas, El Paso, TX (US); Luke Hillebrecht, El Paso, TX (US)

(21) Appl. No.: 18/859,198

(22) PCT Filed: May 31, 2023
(86) PCT No.: PCT/US2023/023920

§ 371 Date: Oct. 23, 2024

Related U.S. Application Data
(60) Provisional application No. 63/349,697, filed on Jun. 7, 2022.

(51) Int. Cl. H01H 19/635; A45D 2/00

(52) U.S. Cl. CPC H01H 19/6355; A45D 2/001

(57) ABSTRACT

A beauty tool includes an outer housing, two or more operational components mounted to or within the outer housing, two or more switches, and a switch track mounted to or within the outer housing. The outer housing defines a styling portion and a handle portion. The two or more switches each have a respective switch portion moveable between two or more switch positions, and they control power delivery to the two or more operational components. The switch track has two or more tracks. Each track is configured to cooperate with a respective switch portion of the two or more switches to enable the respective switch portion to move between the two or more switch positions in response to the switch track being rotated with respect to the outer housing about an axis

### BACKGROUND

It is known to provide a selector assembly on a handle portion of a beauty tool, wherein the selector assembly includes a switching unit adapted to control first and second operational components of the beauty tool (e.g., a heater and a fan motor). The known switching unit is typically a controller (i.e., a knob or switch) fixedly mounted on the handle portion and moveable in two separate directions, one type of directional movement for each operational component. By way of example, the controller can be associated with both a slide variable resistor which changes in resistance value by linear motion of the controller, and a rotation variable resistor which changes in resistance value by rotational movement of the controller. Accordingly, the first operation component is controlled by the linear movement of the controller on the handle portion, and the second operational component is controlled by the separate rotational movement of the controller on the handle portion. However, this type of switching unit to operate the beauty tool can be cumbersome to the user, and can require a large footprint on the handle portion.

### SUMMARY

In view of the foregoing, a beauty tool includes an outer housing, two or more operational components mounted to or within the outer housing, two or more switches, and a switch track mounted to or within the outer housing. The outer housing defines a styling portion and a handle portion. The two or more switches each have a respective switch portion moveable between two or more switch positions, and they control power delivery to the two or more operational components. The switch track has two or more tracks. Each track is configured to cooperate with a respective switch portion of the two or more switches to enable the respective switch portion to move between the two or more switch positions in response to the switch track being rotated with respect to the outer housing about an axis.

In one aspect of the beauty tool, the two or more operational components can include a first operational component being one of a motor or at least one heating element and a second operational component being another of the motor or the at least one heating element. The two or more switches can include a first switch having a first switch portion moveable between two or more first switch positions and a second switch having a second switch portion moveable between two or more second switch positions. The first switch can control power delivery to the first operational component, and the second switch can control power delivery to the second operational component. The switch track can have a first track and a second track. The first track can cooperate with the first switch portion and the second track can cooperate with the second switch portion. The first track can be shaped to enable the first switch portion to move between the two or more first switch positions in response to the switch track being rotated with respect to the outer housing about the axis. The second track can be shaped to enable the second switch portion to move between the two or more second switch positions in response to the switch track being rotated with respect to the outer housing about the axis.

### BRIEF DESCRIPTION OF THE DRAWINGS

FIG. 1 is a block diagram of a beauty tool including an exemplary selector assembly for simultaneously and/or separately controlling at least two operational components of the beauty tool.

FIG. 2 is a side perspective view of an embodiment of the beauty tool including the selector assembly of FIG. 1.

FIG. 3 is a side perspective view of a switch control of the selector assembly of FIG. 1.

FIGS. 4A-4B are side views illustrating different positions associated with grooves of a switch track of the switch control of the selector assembly of FIG. 3.

FIG. 5 is a circuit diagram of a circuit of the selector assembly.

FIG. 6 is an exemplary table of operational modes associated with the circuit of the selector assembly of FIG. 5 in accordance with rotation of the switch track of the switch control of FIGS. 4A-4B.

### DETAILED DESCRIPTION

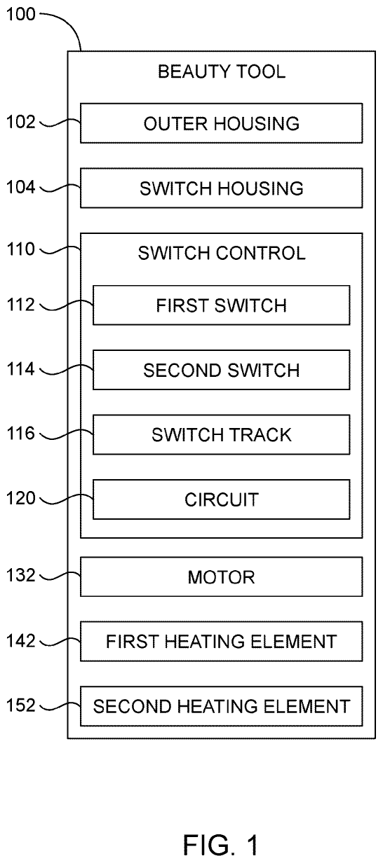

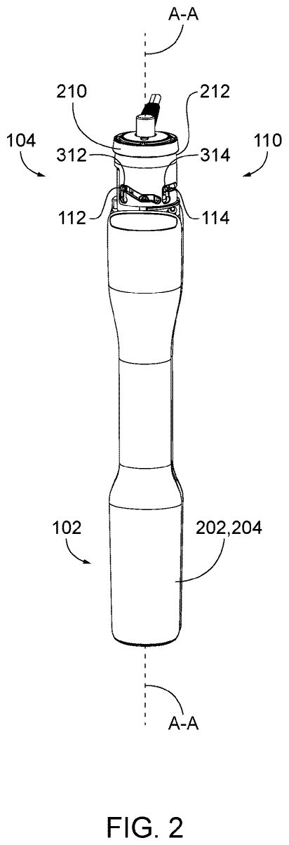

It should, of course, be understood that the description and drawings herein are merely illustrative and that various modifications and changes can be made in the structures disclosed without departing from the present disclosure. Referring now to the drawings, wherein like numerals refer to like parts throughout the several views, FIG. 1 is a block diagram of a beauty tool 100 including an exemplary selector assembly for simultaneously and/or separately controlling at least two operational components (e.g., a motor 132, a first heating element 142, a second heating element 152) of the beauty tool 100. As seen in FIGS. 1 and 2, the beauty tool 100 includes an outer housing 102 that defines both a styling portion and a handle portion of the beauty tool. The selector assembly which is typically provided as part of the handle portion of the beauty tool can include a switch housing 104 and a switch control portion 110 housed by the switch housing 104. The switch control portion 110 can include a first switch 112, a second switch 114, a switch track 116, and a circuit 120. The at least two operational components can include the motor 132, the first heating element 142, and the second heating element 152; although it should be appreciated that the types of operational components are dictated by the type of beauty tool incorporating the selector assembly.

FIG. 2 is a side perspective view of an embodiment of the beauty tool 100, wherein the beauty tool is a handheld straightener. Although, it should be appreciated that alternative embodiments of the beauty tool are contemplated, for example, the beauty tool 100 can be a styling iron, a hairdryer, etc. The beauty tool 100 includes the styling portion having first and second moveable arms 202, 204 that are configured to operate on a person's hair, for example, and the handle portion includes the switch housing 104 of FIG. 1. As depicted, operably associated with the switch housing 104 is a controller 210 that allows a user to control different operational modes of the operational components. The controller 210 can be in the form of a control dial 212 that is rotatable about an axis A-A of the switch housing 104 or the beauty tool. The control dial is operably connected to the switch track 116, wherein rotation of the control dial 212 causes corresponding rotation of the switch track 116 with respect to the outer housing 102 about the axis A-A. The switch track 116 is connected to the first switch 112 and the second switch 114, such that rotational movement of the switch track 116 with respect to the outer housing 102 controls an operational mode for the beauty tool 100 according to positions of the first switch 112 and the second switch 114. Further, the control dial 212 attached to the switch track 116 can enable the user to select between multiple settings on the beauty tool 100 via the circuit 120. Examples of settings which can be adjusted via the circuit 120 include different configurations of air temperature, air speed, comb temperatures, heat plate temperatures, etc., again settings dependent on the type of beauty tool 100.

In FIG. 2, the first switch 112 and the second switch 114 can have a respective a first switch portion 312 and a second switch portion 314 which can be moveable between two or more switch positions. Although two switches are depicted in FIG. 2, embodiments including additional switches (e.g., two or more switches) can be implemented. According to the present disclosure, the handheld straightener of FIG. 2 depicts the first switch 112 having the first switch portion 312 moveable between two or more switch positions and the second switch 114 having the second switch portion 314 moveable between two or more switch positions.

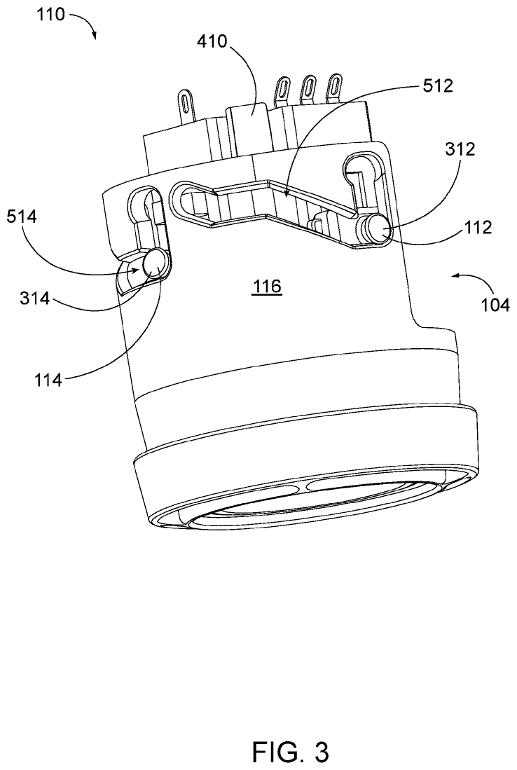

FIG. 3 is a side perspective view of the switch control portion 110 of the beauty tool 100 of FIG. 1, according to one aspect. As shown in FIG. 3, a chassis 410 is mounted to the switch housing 104, specifically the switch track 116. The first switch 112 and the second switch 114 are mounted to a chassis 410 such that rotational movement of the switch track 116 about the axis A-A (via the controller 210) causes linear movement of the respective switch portions 312, 314 in a direction parallel to the axis A-A. However, it can be possible, according to other aspects, to have the switches aligned such that the movement of the respective switch portions are along another axis or direction. According to one aspect, the first switch 112 and the second switch 114 can be slide switches, rotary switches, or another type of switch having switch portions or other moveable protrusions, projections, knobs, etc. which move in a linear fashion.

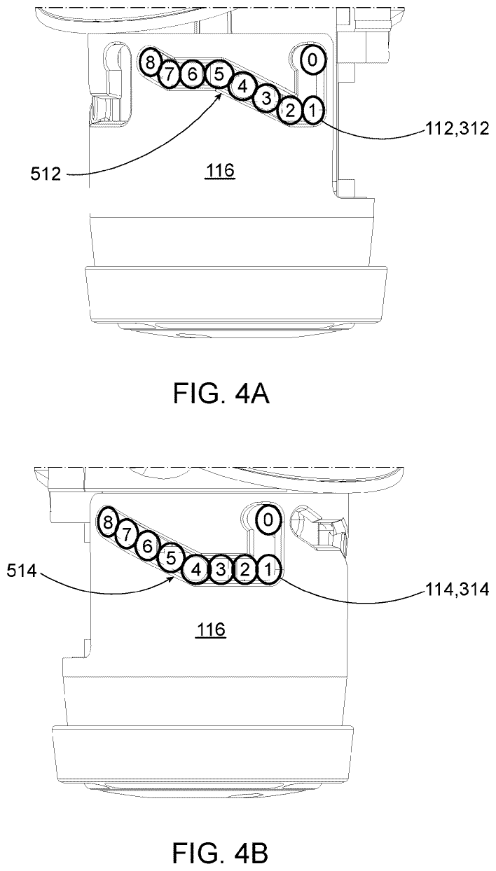

As seen in FIG. 3, the switch track 116 has a first track, which in FIG. 3 is defined by a first track opening 512 and a second track, which in FIG. 3 is defined by a second track opening 514. The first track opening 512 is configured to receive the first switch portion 312 and the second track opening 514 is configured to receive the second switch portion 314. Further, the first track opening 512 is shaped to enable the first switch portion 312 to move between the two or more switch positions when the switch track 116 is rotated with respect to the outer housing 102 about the axis A-A. Similarly, the second track opening 514 is shaped to enable the second switch portion 314 to move between the two or more switch positions when the switch track 116 is rotated with respect to the outer housing 102 about the axis A-A. Therefore, the first track opening 512 and the second track opening 514 can control the switch position of the respective switches. In this regard, additional detail regarding the two or more switch positions is provided in FIGS. 4A-4B.

Although the switch portions depicted in FIG. 3 are switch caps, it will be appreciated that the switch portions can have indentations rather than protrusions or projections. In one example, the switch track 116 can include two or more protrusions or projections which are configured to slide along the respective track openings 512, 514 and mate with the indentations of the switch portions. Alternatively, the switch track 116 can include can include inwardly extending protrusions that define the first track and the second track, respectively, following a similar path to the first and second track openings 512, 514 and the respective switch portions 312, 314 can slide along the first and second tracks in a similar manner to that described in further detail below.

FIGS. 4A-4B are side views illustrating different positions associated with the first and second track openings 512, 514 of the switch track 116 of the switch control portion 110, according to one aspect. In this regard, it can be seen that the shape of the first track opening 512 is different than the shape of the second track opening 514. One advantage of the configuration of the switch track 116 provided in FIGS. 4A-4B is that this configuration enables simultaneous and/or separate control over multiple operational components of the beauty tool 100 while maintaining a lightweight design which does not require a large footprint in the handle portion of the beauty tool.

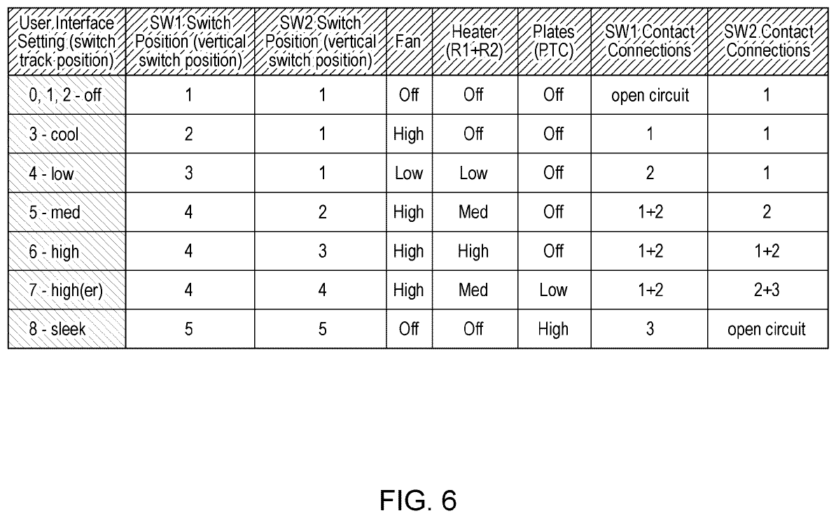

The first track opening 512 of FIG. 4A is configured in a shape which enables the first switch portion 312 of the first switch 112 to move along the first track opening 512 among multiple first switch track positions (e.g., positions 0-8 in FIG. 4A) as the switch track 116 is moved along or rotated about the axis A-A among multiple switch track positions. For example, the first switch portion 312 of the first switch 112 can be moved between five different first switch positions, which correspond to the five different vertical positions in FIG. 4A and are shown in the “SW1 Switch Position (vertical switch position)” column in the table shown in FIG. 6. In this embodiment and with reference to FIG. 4A, first switch track positions 1-2 correspond to first switch position 1, first switch track position 3 corresponds to first switch position 2, first switch track position 4 corresponds to first switch position 3, first switch track positions 5-7 correspond to first switch position 4, and first switch track position 8 corresponds to first switch position 5 for the first switch portion 312 of the first switch 112. Therefore, as the switch track 116 is rotated by the user of the handheld appliance from left to right in FIG. 4A, the switch track 116 will pass through switch track positions 1-8 and change the first switch position of the first switch 112 from first switch position 1 (e.g., corresponding to first switch track positions 1-2) to first switch position 2 (e.g., corresponding to first switch track position 3) to first switch position 3 (e.g., corresponding to first switch track position 4) to first switch position 4 (e.g., corresponding to first switch track position 5-7) to first switch position 5 (e.g., corresponding to first switch track position 8). In this way, the first switch portion 312 of the first switch 112 can be moved from the bottom to the top, as depicted in FIG. 4A.

As seen in FIG. 4B, the second track opening 514 is configured similarly and has a slightly different shape which enables the second switch portion 314 of the second switch 114 to move along the second track opening 514 multiple second switch track positions of FIG. 4B (e.g., positions 0-8 in FIG. 4B) as the switch track 116 is moved along or rotated about the axis A-A among multiple switch track positions. With reference to FIGS. 4A and 4B, when the switch track 116 is in a respective switch track position, e.g., among nine different switch track positions 0-8 in FIGS. 4A and 4B, both the first switch portion 312 and the second switch portion 314 reside in the same respective switch track position. As such, when the first switch portion 312 is in first switch track position 1 in FIG. 4A, the second switch portion is in second switch track position 1 in FIG. 4B and the switch track 116 is in track position 1. Likewise, when the first switch portion 312 is in first switch track position 2 in FIG. 4A, the second switch portion is in second switch track position 2 in FIG. 4B and the switch track 116 is in track position 2, and so on.

For example, the second switch portion 314 of the second switch 114 can be moved between five different second switch positions, which correspond to the five different vertical positions in FIG. 4B and are shown in the “SW2 Switch Position (vertical switch position)” column in the table shown in FIG. 6. In this embodiment and with reference to FIG. 4B, second switch track positions 1-4 correspond to second switch position 1, second switch track position 5 corresponds to second switch position 2, second switch track position 6 corresponds to second switch position 3, second switch track position 7 corresponds to second switch position 3, and second switch track position 8 corresponds to second switch position 5 for the second switch portion 314 of the second switch 114. Therefore, as the switch track 116 is rotated by the user of the handheld appliance from left to right in FIG. 4B, the switch track 116 will pass through switch track positions 1-8 and change the second switch position of the second switch 114 from the second switch position 1 (e.g., corresponding to second switch track positions 1-4) to second switch position 2 (e.g., corresponding to second switch track position 5) to second switch position 3 (e.g., corresponding to second switch track position 6) to second switch position 4 (e.g., corresponding to second switch track position 7) to second switch position 5 (e.g., corresponding to second switch track position 8). In this way, the second switch portion 314 of the second switch 114 can be moved from the bottom to the top, as depicted in FIG. 4B.

Although FIG. 4A is described with respect to the first switch 112 and FIG. 4B is described with respect to the second switch 114, it will be appreciated that rotation of the switch track 116 may cause the switch portions 312, 314 of the respective first and second switches 112, 114 to move simultaneously or concurrently from one switch position to another switch position in some instances or individually from one switch position to another switch position without causing the other switch to move another switch position in other instances.

For example, as already discussed, first switch track position 2 in FIG. 4A corresponds to the first switch position 1 for the first switch 112 and second switch track position 2 in FIG. 4B corresponds to the second switch position 1 for the second switch 114. Rotation of the switch track 116 resulting in movement from first switch track position 2 to first switch track position 3 results in merely the first switch 112 changing first switch positions. In first switch track position 3 for the switch track 116, the first switch 112 is set to first switch position 2 while the second switch 114 remains in the second switch position 1 (see also FIG. 6). Therefore, the shape of the first track opening 512 and the second track opening 514 at these positions is configured such that rotation of the switch track 116 merely causes individual operational movement of a single switch.

However, other portions of the switch track 116 are configured for simultaneous operational movement for the first and second switch portions 312, 314 of the first switch 112 and the second switch 114. For example, at first switch position 7 for the switch portion 312 and at corresponding second switch position 7 for the second switch portion 314, both the first switch 112 and the second switch 114 are set to their respective switch position 4. Rotation of the switch track 116 resulting in movement of the first switch portion 312 from first track position 7 to first track position 8 results in both the first switch 112 and the second switch 114 being moved to their respective switch position 5 because rotation of the switch track 116 resulting in movement of the first switch portion 312 from first track position 7 to first track position 8 also results movement of the second switch portion 314 from second track position 7 to second track position 8. Therefore, the shape of the first track opening 512 and the second track opening 514 at these positions is configured such that rotation of the switch track 116 causes synchronized or dual operational movement of both switches 112, 114. In this way, the first track opening 512 and the second track opening 514 of the switch track 116 provide for simultaneous and/or separate control of at least two operational components, e.g. the motor 132, the first heating element 142, and/or the second heating element 152 of the beauty tool 100.

Further, this design enables the user of the beauty tool to change operational modes by merely rotating the switch track 116 a comfortable amount (e.g., enough to notice a change in rotation) while maintaining the tactile feel provided by the change between switch positions. As an added benefit, the simultaneous movement of both switch portions 312, 314 of the first and second switches 112, 114 can provide the user with additional feedback that the operational mode of the beauty tool 100 has been changed for some scenarios.

Switch track position 0 for both the first switch portion 312 in the first track opening 512 and the second switch portion 314 in the second track opening 514 can be a lock position or storage position which inhibits rotational movement of the switch track 116 about the axis A-A of the beauty tool 100 when the switch track 116 is moved downward with respect to FIGS. 4B-4A. The switch track 116 can be slid along the axis A-A of the beauty tool 100 to configure the switch track 116 to be in switch track position 0 for both the first switch portion 312 and the second switch portion 314. When in switch track position 0, there is no change to the position of the switch portions 312, 314 of the respective switches 112, 114. In other words, the switch position of the first switch 112 and the switch position of the second switch 114 are identical when in switch track positions 0 and 1. Therefore, switch position 0 for the switch track position of the switch track 116 can cause the respective switches 112, 114 to be locked into the switch position 1 for both switches 112, 114.

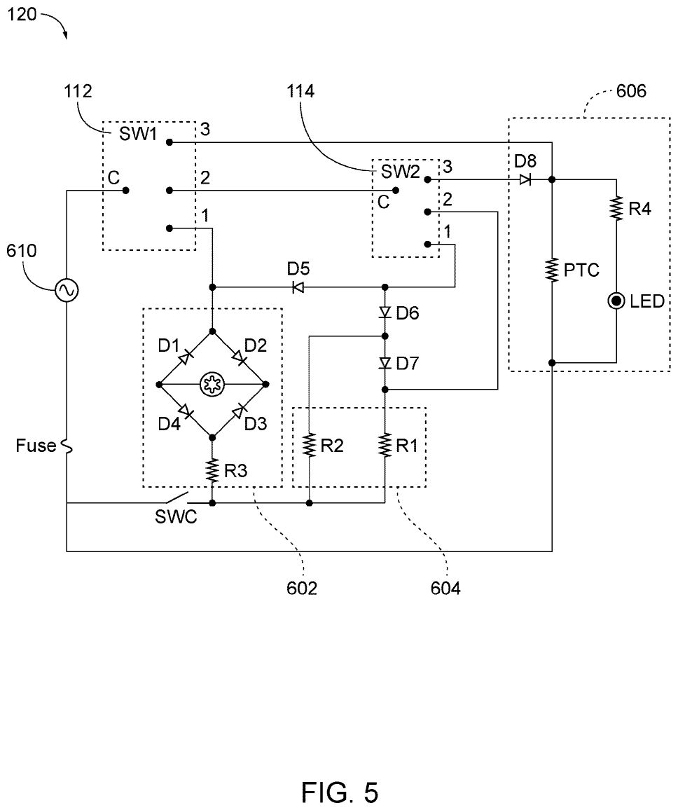

FIG. 5 is a circuit diagram of the exemplary circuit 120 of the beauty tool 100 of FIG. 1, according to one aspect. As seen in FIG. 5, the circuit 120 can include the first switch 112, the second switch 114, and additional circuit portions 602, 604, 606 can be selectively electrically connected to a power source 610 on the circuit based on a position of the first switch portion 312 and the position of the second switch portion 314 via the rotation of the switch track 116 about the axis A-A of the beauty tool 100. Additional circuit portions 602, 604, 606 can include one or more of the motor 132 and/or the heating elements 142, 152. Although three circuit portions 602, 604, 606 are depicted in FIG. 5, embodiments including fewer or additional circuit portions (e.g., two or more circuit portions) can be implemented.

In FIG. 5, the first switch 112 and the second switch 114 are shown according to an aspect where the switches each have merely three different electrical contact connections (e.g., contacts 1, 2, 3 for each switch). However, as will be appreciated, any number of electrical contact connections can be implemented, as well as any number of switches beyond the first switch 112 and the second switch 114. The additional circuit portion 602 of FIG. 6 can include the motor 132 of FIG. 1 and a diode bridge D1, D2, D3, D4 arranged to provide DC current to the motor 132. The motor 132 can drive fan blades of a fan (not shown) in a conventional manner. The additional circuit portion 604 can be the first heating element 142 of FIG. 1 which can be adjusted between various off, low, medium, and high settings via diodes D6-D7. The additional circuit portion 606 can be the second heating element 152, such as a positive temperature coefficient (PTC) element, which may be thermally connected to a plate such that heat from the heating element is transferred to the plate when the heating element is operational.

According to one aspect, component SWC in FIG. 5 can be a switch that is configured to close when the first and second moveable arms 202, 204 of the beauty tool 100 are in a closed position, as depicted in FIG. 2, and open when the first and second moveable arms 202, 204 of the beauty tool 100 are in an open position. As is known with handheld straighteners, the first and second moveable arms 202, 204 are biased to the open position. In this way, SWC can automatically, via the movement of the arms, enable and disable the additional circuit portions 602, 604 in a seamless fashion which is easily controlled by a grip of the user pressing the first and second moveable arms 202, 204 together.

FIG. 6 is an exemplary table of operational modes associated with the circuit 120 of the selector assembly of FIG. 5 in accordance with rotation of the switch track 116 of the switch control of FIGS. 4A-4B, according to one aspect. In FIG. 6, when the user interface setting or the switch track position of the switch track 116 is set to switch track position 0, 1, or 2, the switch position of the first and second switch portions 312, 314 of the first and switches 112, 114 are both at switch position 1. With reference to the electrical contact connections for the first switch 112 (i.e., SW1 in FIG. 6), the first switch 112 is in an open configuration. Regarding the electrical contact connections of the second switch 114 (i.e., SW2 in FIG. 6), the second switch 114 connects point C with the electrical contact 1. Since the first switch 112 is in the open configuration, no current can flow through the circuit 120 as no loop is formed in this scenario. Therefore, each of the motor 132 associated with circuit portion 602, the first heating element 142 associated with circuit portion 604, the second heating element 152 associated with circuit portion 606 are off.

When the user interface setting or the position of the switch track 116 is set to switch track position 3, the switch position of the first switch portion 312 of the first switch 112 is set to the first switch position 2 (e.g., the second from bottom position of FIG. 4A) and the second switch position of the second switch portion 314 of the second switch 114 remains set to the second switch position 1 (e.g., the bottom position of FIG. 4B). With reference to the electrical contact connections for the first switch 112, the first switch 112 connects point C with the electrical contact 1. Regarding the electrical contact connections of the second switch 114, the second switch 114 connects point C with the electrical contact 1. When the first switch 112 closes and electrically connects point C with electrical contact 1, AC current flows through the diode bridge (diodes D1-D4), which acts as a bridge rectifier to convert the AC current into a DC output for the motor 132 and associated circuit portion 602, thereby operating the fan in a high operational mode. The connection of the second switch 114 does not come into play until the first switch 112 forms a loop by connecting point C with the electrical contact 2 and thus, the first heating element 142 associated with circuit portion 604 and the second heating element 152 associated with circuit portion 606 are off in this scenario.

When the user interface setting or the position of the switch track 116 is set to switch track position 4, the switch position of the first switch portion 312 of the first switch 112 is set to first switch position 3 (e.g., the third from bottom position of FIG. 4A) and the switch position of the second switch portion 314 of the second switch 114 remains set to second switch position 1 (e.g., the bottom position of FIG. 4B). With reference to the electrical contact connections for the first switch 112, the first switch 112 connects point C with the electrical contact 2. Regarding the electrical contact connections of the second switch 114, the second switch 114 connects point C with the electrical contact 1. When the first switch 112 closes and electrically connects point C with electrical contact 2, current can flow to the second switch 114. The connection of the second switch 114 from point C to electrical contact 1 forms a loop where current may flow through either diode D5 or diode D6. Due to the current passing through diode D5 (and due to the associated voltage drop) and into the bridge rectifier and associated circuit portion 602, the motor 132, and thus any connected fan blade, will operate in a slower state than when current is directly fed in from the electrical contact 1 of the first switch 112. Similarly, diodes D6, D7 enable the first heating element 142 associated with circuit portion 604 to operate at a lower operational setting (e.g., at a low mode) due to passing through both diode D6 and diode D7. Therefore, the motor 132 associated with circuit portion 602 and the first heating element 142 associated with circuit portion 604 are operational in a low operational mode, while the second heating element 152 associated with circuit portion 606 is off.

When the user interface setting or the position of the switch track 116 is set to switch track position 5, the switch position of the first switch portion 312 of the first switch 112 is set to first switch position 4 (e.g., the fourth from bottom position of FIG. 4A) and the switch position of the second switch portion 314 of the second switch 114 is set to second switch position 2 (e.g., the second from bottom position of FIG. 4B). With reference to the electrical contact connections for the first switch 112, the first switch 112 connects point C with electrical contacts 1 and 2. Regarding the electrical contact connections of the second switch 114, the second switch 114 connects point C with the electrical contact 2. By virtue of the connection of the first switch 112 from point C to electrical contact 1, the fan associated with the motor 132 is in a high operational mode. The connection of the first switch 112 from point C to electrical contact 2 enables the second switch to effectively form a loop via the electrical connection between point C and electrical contact 2. In this scenario, current merely flows through resistor R1 of the additional circuit portion 604, thereby causing the first heating element 142 to be operational in a medium operational mode while bypassing use of the resistor R2. Therefore, the motor 132, which can drive a fan, associated with circuit portion 602 operates in the high operational mode, the first heating element 142 associated with circuit portion 604 operates in a medium operational mode, while the second heating element 152 associated with circuit portion 606 is off.

When the user interface setting or the position of the switch track 116 is set to switch track position 6, the switch position of the first switch portion 312 of the first switch 112 is set to first switch position 4 (e.g., the fourth from bottom position of FIG. 4A) and the switch position of the second switch portion 314 of the second switch 114 is set to second switch position 3 (e.g., the third from bottom position of FIG. 4B). With reference to the electrical contact connections for the first switch 112, the first switch 112 connects point C with electrical contacts 1 and 2. Regarding the electrical contact connections of the second switch 114, the second switch 114 connects point C with electrical contacts 1 and 2. As indicated above, the connection of the first switch 112 from point C to electrical contact 1 causes the fan to operate in a high operational mode. The connection of the first switch 112 from point C to electrical contact 2 enables the second switch to effectively form a loop via the electrical connection between point C and electrical contacts 1 and 2. In this scenario, some current flows through R1 of the additional circuit portion 604 (without passing through diode D7), through resistor R2 via diode D6, and through resistor R1 via diodes D6-D7, thereby causing the first heating element 142 to be operational in a high operational mode. In this way, the motor 132, which can drive a fan, associated with circuit portion 602 operates in the high operational mode, the first heating element 142 associated with circuit portion 604 operates in a high operational mode, while the second heating element 152 associated with circuit portion 606 is off.

When the user interface setting or the position of the switch track 116 is set to switch track position 7, the switch position of the first switch portion 312 of the first switch 112 is set to the first switch position 4 (e.g., the fourth from bottom position of FIG. 4A) and the switch position of the second switch portion 314 of the second switch 114 is set to the second switch position 4 (e.g., the fourth from bottom position of FIG. 4B). With reference to the electrical contact connections for the first switch 112, the first switch 112 connects point C with electrical contacts 1 and 2. Regarding the electrical contact connections of the second switch 114, the second switch 114 connects point C with electrical contacts 2 and 3. As indicated above, the connection of the first switch 112 from point C to electrical contact 1 causes the fan to operate in a high operational mode. Again, the connection of the first switch 112 from point C to electrical contact 2 enables the second switch to effectively form a loop via the electrical connection between point C and electrical contacts 2 and 3. As discussed already, current merely flows through resistor R1 of the additional circuit portion 604, thereby causing the first heating element 142 to be operational in the medium operational mode while bypassing use of the resistor R2. Additionally, the connection between point C and electrical contact 3 of the second switch 114 forms another loop which enables current to flow through diode D8 and to the second heating element 152, which is depicted as a PTC element in FIG. 6. Due to the current flow through diode D8, this results in the second heating element 152 associated with circuit portion 606 operating in a low operational mode. In this way, the motor 132, which can drive a fan, associated with circuit portion 602 operates in the high operational mode, the first heating element 142 associated with circuit portion 604 operates in the medium operational mode, while the second heating element 152 associated with circuit portion 606 operates in the low operational mode.

When the user interface setting or the position of the switch track 116 is set to switch track position 8, the switch position of the first switch portion 312 of the first switch 112 is set to first switch position 5 (e.g., the top position of FIG. 4A) and the switch position of the second switch portion 314 of the second switch 114 is set to second switch position 5 (e.g., the top position of FIG. 4B). With reference to the electrical contact connections for the first switch 112, the first switch 112 connects point C with electrical contact 3. Regarding the electrical contact connections of the second switch 114, the second switch 114 is in an open configuration. The connection between point C and electrical contact 3 of the first switch 112 forms a loop which enables current to flow through the second heating element 152 while bypassing the diode D8, thereby causing the second heating element 152 associated with circuit portion 606 to operate in a high operational mode, while the motor 132 associated with circuit portion 602 and the first heating element 142 associated with circuit portion 604 are off.

It will be appreciated that the above-disclosed embodiments and other features and functions, or alternatives or varieties thereof, can be desirably combined into many other different systems or applications. Also, that various presently unforeseen or unanticipated alternatives, modifications, variations or improvements therein can be subsequently made by those skilled in the art which are also intended to be encompassed by the following claims.

1. A beauty tool comprising:
an outer housing defining a styling portion and a handle portion;
two or more operational components mounted to or within the outer housing;
two or more switches, each having a respective switch portion moveable between two or more switch positions, wherein the two or more switches control power delivery to the two or more operational components; and
a switch track mounted to or within the outer housing and having two or more tracks, wherein each track is configured to cooperate with a respective switch portion of the two or more switches to enable the respective switch portion to move between the two or more switch positions in response to the switch track being rotated with respect to the outer housing about an axis.

2. The beauty tool of claim 1, wherein the two or more switches are slide switches, each having a respective switch portion slidable in a direction parallel to the axis about which the switch track rotates.

3. The beauty tool of claim 1, wherein the two or more tracks are each defined by a respective track opening in the switch track.

4. The beauty tool of claim 1, wherein the two or more operational components include a motor or at least one heating element.

5. The beauty tool of claim 1, wherein the two or more operational components includes a first operational component being one of a motor or at least one heating element and a second operational component being another of the motor or the at least one heating element;
wherein the two or more switches includes a first switch having a first switch portion moveable between two or more first switch positions and a second switch having a second switch portion moveable between two or more second switch positions, the first switch controlling power delivery to the first operational component, and the second switch controlling power delivery to the second operational component;
wherein the switch track includes a first track and a second track, wherein the first track cooperates with the first switch portion and the second track cooperates with the second switch portion, wherein the first track is shaped to enable the first switch portion to move between the two or more first switch positions in response to the switch track being rotated with respect to the outer housing about the axis, wherein the second track is shaped to enable the second switch portion to move between the two or more second switch positions in response to the switch track being rotated with respect to the outer housing about the axis.

6. The beauty tool of claim 5, further comprising a circuit including the first switch, the second switch, a first circuit portion, and a second circuit portion, wherein the first circuit portion is operably associated with the first operational component and the second circuit portion is operably associated with the second operational component, wherein each of the first circuit portion and the second circuit portion are selectively electrically connected to a power source of the circuit based on a respective first switch position of the first switch portion and a respective second switch position of the second switch portion.

7. The beauty tool of claim 5, wherein the first track is differently shaped than the second track.

8. The beauty tool of claim 7, wherein rotation of the switch track about the axis results in displacement of the first switch portion from one of the two or more first switch positions to another of the two or more first switch positions and in displacement of the second switch portion from one of the two or more second switch positions to another of the two or more second switch positions along at least a portion of rotational travel of the switch track about the axis.

9. The beauty tool of claim 7, wherein rotation of the switch track about the axis results in displacement of the first switch portion from one of the two or more first switch positions to another of the two or more first switch positions and no displacement the second switch portion along at least a portion of rotational travel of the switch track about the axis.

10. The beauty tool of claim 7, wherein rotation of the switch track about the axis results in displacement of the second switch portion from one of the two or more second switch positions to another of the two or more second switch positions and no displacement the first switch portion along at least a portion of rotational travel of the switch track about the axis.

11. The beauty tool of any of claim 5, wherein the first operational component is a motor for a fan.

12. The beauty tool of any of claim 5, wherein the second operational component is a resistive heating element.

13. The beauty tool of any of claim 5, further comprising a third operational component and a third circuit portion operably associated with the third operational component.

14. The beauty tool of claim 13, wherein the third operational component is another heating element.

15. The beauty tool of claim 13, wherein the second switch controls power delivery to the third operational component.

16. The beauty tool of any of claim 5, wherein the first switch controls power delivery to the second switch.
